(19) United States
(12) Patent Application Publication
(10) Pub. No.: US 2002/0101144 A1
(43) Pub. Date: Aug. 1, 2002

(54) Christmas bulb structure

(76) Inventor: Wun Fang Pan, Hsinchu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/769,478

(22) Filed: Jan. 26, 2001

(51) Int. Cl. H01J 1/02; H01J 19/42

(52) U.S. Cl. 313/37; 313/271

(57) ABSTRACT

The present invention relates to a Christmas bulb structure, which is provided with a pair of conducting wire in the bulb and one filament and two or more fuses connecting with the two conducting wires in parallel. It increases the well rate of the assembled light string and prevents the bulb from broken caused of the filament being burned out. And also it lengthens the used period of the bulb and the light string.

### BACKGROUND OF THE INVENTION

A conventional Christmas bulb structure is provided with a pair of conducting wire in the bulb wherein a filament is connected with the two conducting wires. Another fuse is also provided in the bulb, which is parallel to the filament and is connected with the two conducting wires for maintaining electrical connection if the filament is burned out. An improved design is to provide with two parallel filaments (12) between the two conducting wires (11) in the bulb (1), as shown in FIG. 1. That keeps the bulb (1) lighting when one filament (12) is burned out under the other one still working and increases the using period for the bulb (1). But in truth, as one filament (12) is burned out, the other filament (12) in the bulb (1) will be burned out very soon because of the suddenly increasing electric current. The rest only one fuse in the bulb (1) provides the same effect of electrical connecting as a prior art structure.

The primary object of the present invention is to provide a Christmas bulb structure, which is provided with two parallel fuses for connecting to obtain a better rate in manufacturing of the bulb and lengthen the using period of the bulb. Now the features and advantages of the present invention will be described in detail with reference to the accompanying drawings.

### BRIEF DESCRIPTION OF ACCOMPANYING DRAWINGS

FIG. 1 is a perspective view of a conventional Christmas bulb with two filaments therein.

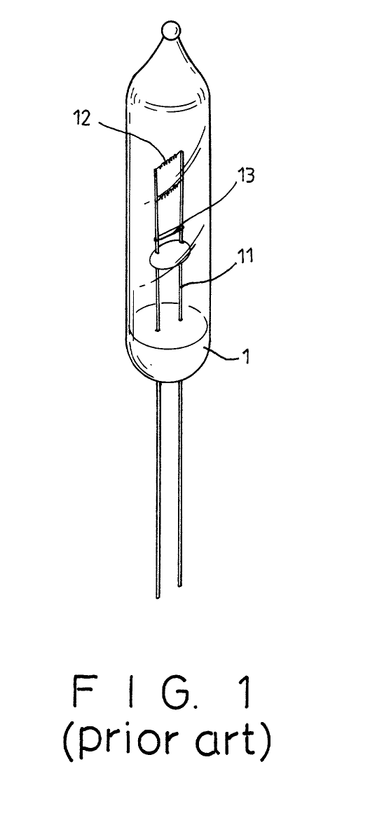

FIG. 2 is a perspective view of a Christmas bulb structure according to the present invention.

### DETAILED DESCRIPTION OF PREFERRED EMBODIMENTS

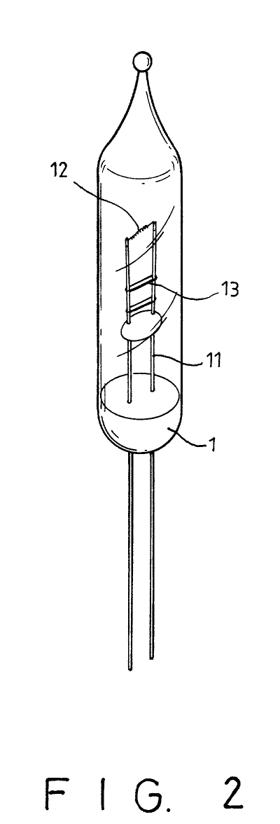

Referring to the FIG. 2, the present invention is to provide an improved Christmas bulb (1), which includes a pair of conducting wire (11) in the bulb (1). A filament (12) and two fuses (13) are connected between the two conducting wires (11) in parallel. Due to the two fuses are provided in the bulb (1) of the present invention, the well rate of the manufactured bulb will be better than before. It is known that about 10 percent of a light bulb string assembled with prior bulbs will be unable to working. The rate will be reduced to one percent under double fuses according to this invention that provides a perfect effect.

Furthermore, the bulb of the present invention has two fuses to protect the light bulb string being actually electrical connecting in use. So it also lengthens the used period of the string. It is to be understood that an expectedly modification can be completed easily and will be claimed in this invention, such as to increase a third fuse or more in the bulb. Evidently the invention has the essence of a patent. We hereby apply for a patent grant.

What is claimed is:

1. A Christmas bulb structure including a pair of conducting wire in the bulb being provided with a filament and two fuses therebetween in parallel.

2. The Christmas bulb structure as claimed in claim 1, wherein the number of fuses provided in the bulb being more than two.
